(19) United States
(12) Patent Application Publication
(10) Pub. No.: US 2016/0364024 A1
(43) Pub. Date: Dec. 15, 2016

(54) CAPACITIVE POINTER

(71) Applicant: WALTOP INTERNATIONAL CORPORATION, Hsinchu City (TW)

(72) Inventor: Chien-Chia Lien, Hsinchu City (TW)

(21) Appl. No.: 14/826,062

(22) Filed: Aug. 13, 2015

(30) Foreign Application Priority Data
Jun. 12, 2015 (TW) 104209503

(51) Int. Cl. G06F 3/0354; G06F 1/26; G06F 3/044; G06F 3/038

(52) U.S. Cl. CPC G06F 3/03545; G06F 3/038; G06F 1/26; G06F 3/044

(57) ABSTRACT

A capacitive pointer is disclosed. The capacitive pointer comprises a conductive nib, a contact device, a device holder, a pressure sensor, a sensor board, a control circuit board and a power source. The device holder covers the pressure sensor and both are mounted on the sensor board. The contact device penetrates the device holder so that when the conductive nib applies a tip pressure against the pressure sensor through the contact device, the pressure sensor can detect the tip pressure applied upon the capacitive pointer. The conductive nib electrically connects the control circuit board. The sensor board electrically connects the control circuit board. The power source provides the capacitive pointer with an electrical power.

### CROSS-REFERENCE TO RELATED APPLICATIONS

The entire contents of Taiwan Patent Application No. 104209503, filed on Jun. 12, 2015, from which this application claims priority, are expressly incorporated herein by reference.

### 1. FIELD OF THE INVENTION

The present invention relates to a pointer, and more particularly to a capacitive pointer.

### 2. DESCRIPTION OF THE PRIOR ART

While capacitive touch input technology allows users to initiate various input operations by various gestures, a capacitive pointer can further provide users with exquisite and multifunctional writing input operation. The invention provides a capacitive pointer having a tip pressure detection function and different configuration and structure comparing to conventional capacitive pointers.

### SUMMARY OF THE INVENTION

An object of the present invention is to provide a capacitive pointer with different configuration and structure comparing to conventional capacitive pointers.

According to the object, one embodiment of the present invention provides a capacitive pointer comprising a conductive nib, a nib holder, a contact device, a device holder, a pressure sensor, a sensor board, a control circuit board, and a power source. One end of the conductive nib is in the nib holder, the device holder covers the pressure sensor mounted on the sensor board, the contact device penetrates the device holder so that the conductive nib pushes the contact device to press the pressure sensor when a tip pressure is applied on the conductive nib, the pressure sensor detects the tip pressure applied upon the conductive nib. The sensor board electrically connects to the control circuit board to calculate a tip pressure value applied upon the capacitive pointer apparatus. The power source provides the capacitive pointer apparatus with electrical power.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 is a schematic view of a capacitive pointer according to one embodiment of the invention.

FIG. 2 is a schematic view of an inner structure of a capacitive pointer according to one embodiment of the invention.

FIG. 3 is another schematic view of an inner structure of a capacitive pointer according to one embodiment of the invention.

FIG. 4 is an exploded view of a capacitive pointer according to one embodiment of the invention.

FIG. 5 is schematic view showing partial structure of a capacitive pointer according to one embodiment of the invention.

FIG. 6 is another schematic view of an inner structure of a capacitive pointer according to one embodiment of the invention.

FIG. 7 is another exploded view of a capacitive pointer according to one embodiment of the invention.

### DESCRIPTION OF THE PREFERRED EMBODIMENT

The detailed description of the present invention will be discussed in the following embodiments, which are not intended to limit the scope of the present invention, but can be adapted for other applications. While drawings are illustrated in details, it is appreciated that the scale of each component may not be expressly exactly.

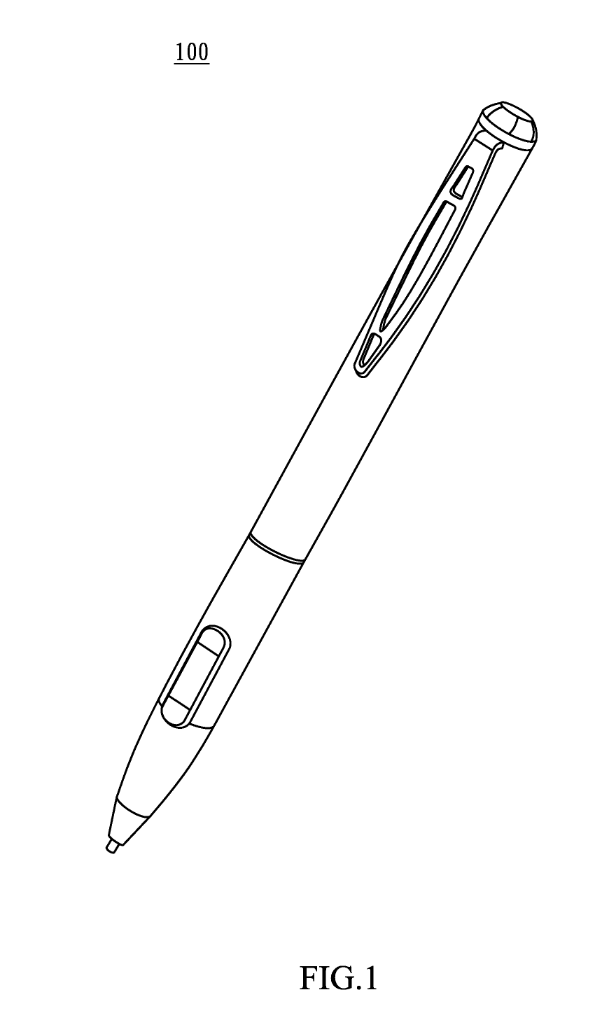

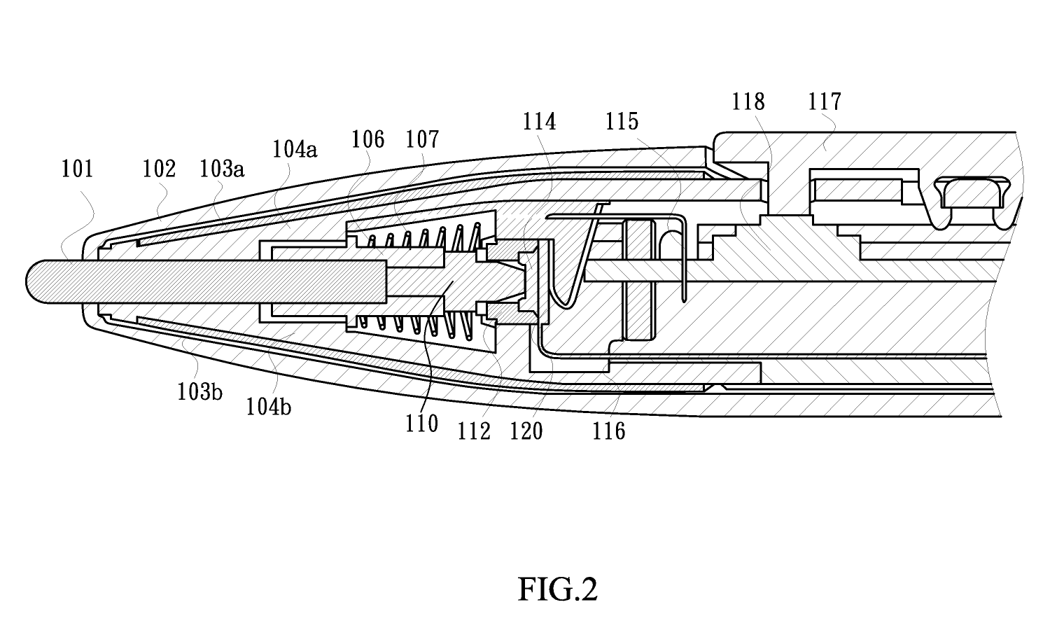

FIG. 1 is a schematic view of a capacitive pointer according to one embodiment of the invention. FIG. 2 is a schematic view of an inner structure of a capacitive pointer according to one embodiment of the invention. The capacitive pointer 100 comprises a nib 101, a first tube 102, a first cover 103a and a second cover 103b, a first structure 104a and a second structure 104b, a nib holder 106, a spring 107, a contact device 110, a device holder 112, a pressure sensor 114, a connection wire 115, a flexible flat cable 116, a button 117, a control circuit board 118 and a sensor board 120.

As shown in FIG. 2, one portion of the contact device 110 penetrates through an opening of the device holder 112, while other portion of the contact device 110 is outside the device holder 112. In this embodiment, one end of the contact device 110 is through the device holder 112 and will contact the pressure sensor 114 after being pressed, while the other end of the contact device 110 contacts the nib 101 in the nib holder 106. However, this configuration is just an example, not a limitation. The material of the contact device 110 comprises, but not limited to, a non-electrical conductive elastomer. The pressure sensor 114 is mounted on the sensor board 120 by any suitable method such as soldering. The sensor board 120 connects to the control circuit board 118 through the flexible flat cable 116. The button 117 is configured to operate a switch to allow a user to select, or to turn on/off various functions of the capacitive pointer. It is noted that the configuration, shape and material of the components of the embodiment mentioned above and shown in FIG. 2 are examples instead of limitations, any equivalents, alternatives or modifications of the embodiment corresponding to the spirit of invention should be encompassed in the scope of the invention.

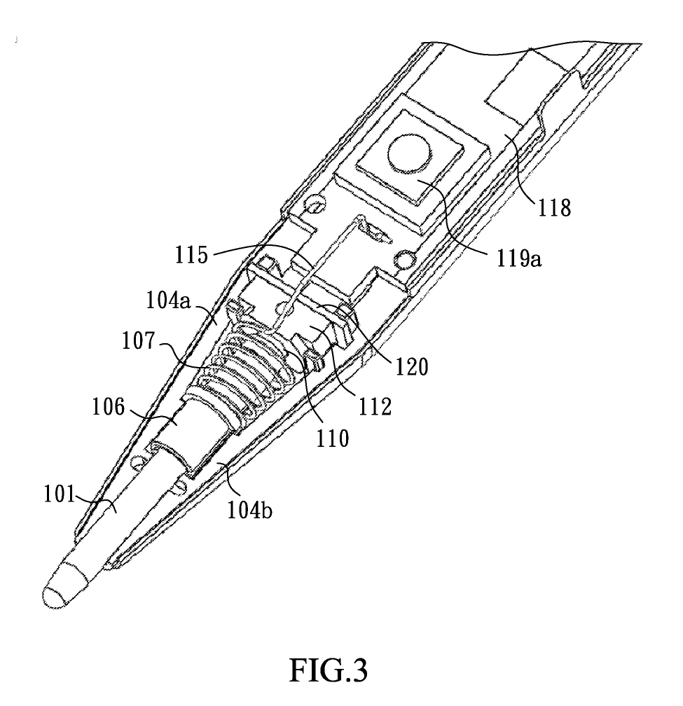

FIG. 3 is another schematic view of an inner structure of a capacitive pointer according to one embodiment of the invention. As shown in FIG. 3, the second structure 104b comprises fillisters and partition frames for accommodating and mounting the nib 101, the nib holder 106, the spring 107, the contact device 110, the device holder 112, the control circuit board 118 and the sensor board 120. The control circuit board 118 has switches 119a and 119b thereon which can be operated by the button 117 to select, or to turn on/off various functions of the capacitive pointer.

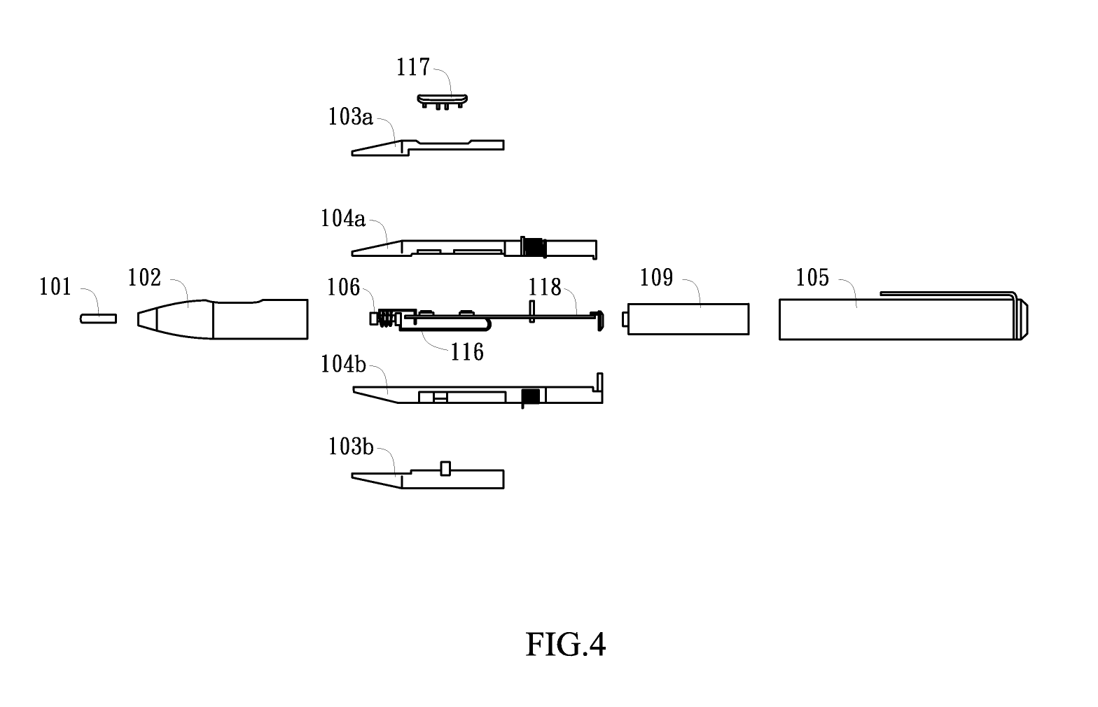

FIG. 4 is an exploded view of a capacitive pointer according to one embodiment of the invention. As shown in FIG. 4, the capacitive pointer further comprises a second tube 105 and a power source 109 beside the nib 101, the first tube 102, the first cover 103a and the second cover 103b, the first structure 104a and the second structure 104b, the nib holder 106, the flexible flat cable 116, the button 117, and the control circuit board 118. The first structure 104a and the second structure 104b are configured to combine to secure the nib holder 106, the device holder 112, the control circuit board 118 and the sensor board 120.

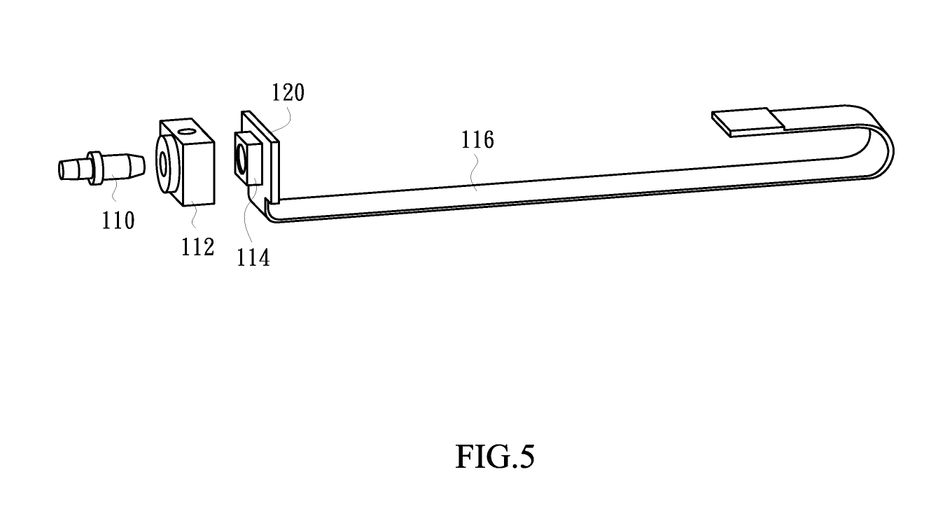

FIG. 5 is schematic view showing partial structure of a capacitive pointer according to one embodiment of the invention. As shown in FIG. 5, a portion of the contact device 110 is configured to penetrate the device holder 112 and to contact the pressure sensor 114 soldered on the sensor board 120. The sensor board 120 connects with the flexible flat cable 116.

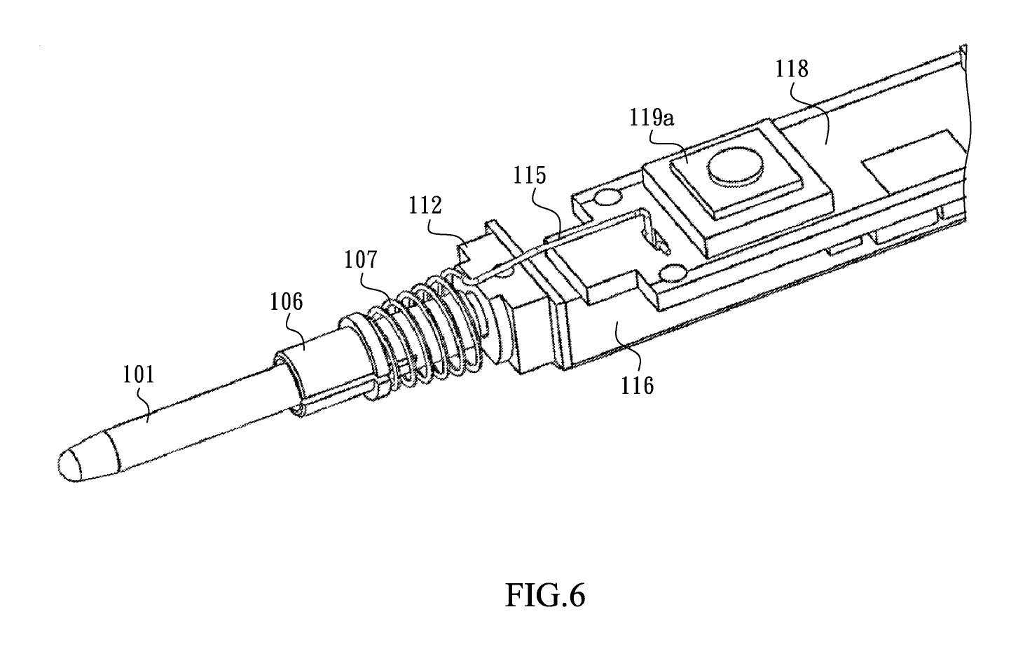

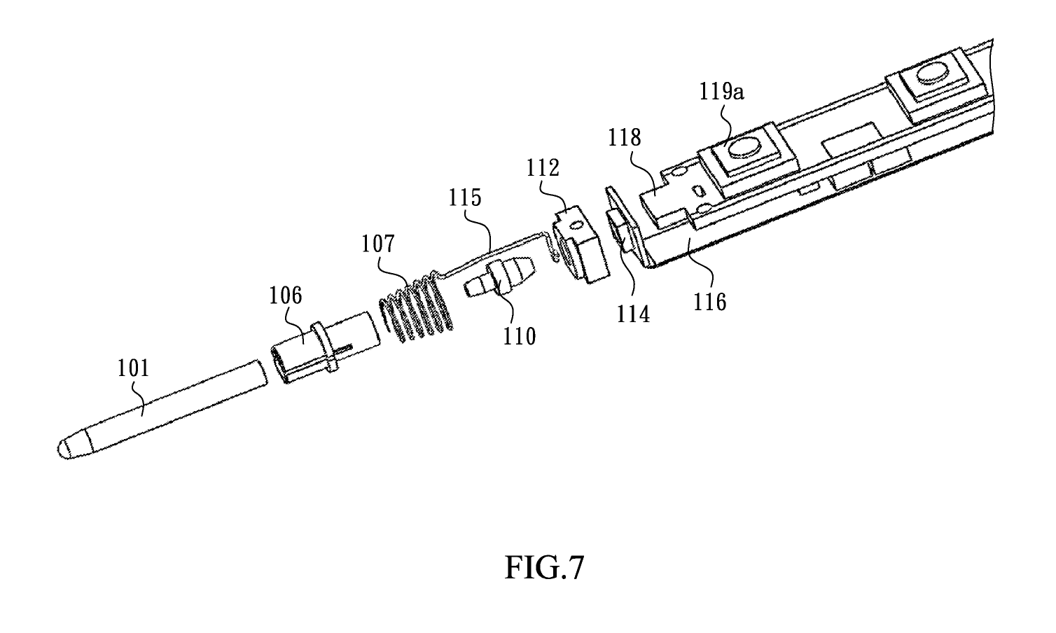

FIG. 6 is another schematic view of an inner structure of a capacitive pointer according to one embodiment of the invention. FIG. 7 is another exploded view of a capacitive pointer according to one embodiment of the invention. As shown in FIGS. 6 and 7, one end of the nib 101 is configured to penetrate through the nib holder 106. The spring 107 is configured to surround one end of the nib holder 106. One end of the contact device 110 is configured to penetrate through the nib holder 106, while the other end of the contact device 110 is configured to penetrate through the device holder 112. The nib 101 comprises an electrical conductive nib. When a tip pressure is applied upon the nib 101, the tip pressure on the nib 101 is also applied on and will be detected by the pressure sensor 114 through the nib holder 106 and the contact device 110. The pressure sensor 114 transmits signals to the control circuit board 118 via the sensor board 120 and the flexible flat cable 116 so as to calculate the tip pressure applied upon the capacitive pointer. The nib 101, the nib holder 106 and the contact device 110 can recoil back to their original position due to restoring force of the spring 107 after the tip pressure applied on the nib 101 vanishes. The configuration, shape and material of the components of the embodiment mentioned above are only examples instead of limitations, any equivalents, alternatives or modifications of the embodiment corresponding to the spirit of invention should be encompassed in the scope of the invention.

Although specific embodiments have been illustrated and described, it will be appreciated by those skilled in the art that various modifications may be made without departing from the scope of the present invention, which is intended to be limited solely by the appended claims.

What is claimed is:

1. A capacitive pointer, comprising:
a conductive nib and a nib holder, wherein one end of the conductive nib is in the nib holder;
a contact device, a device holder, a pressure sensor, and a sensor board, wherein the device holder covers the pressure sensor mounted on the sensor board, the contact device penetrates the device holder so that the conductive nib pushes the contact device to press the pressure sensor when a tip pressure is applied on the conductive nib, the pressure sensor detects the tip pressure applied upon the conductive nib;
a control circuit board, the sensor board electrically connecting to the control circuit board to calculate a tip pressure value applied upon the capacitive pointer apparatus; and
a power source, the power source providing the capacitive pointer apparatus with electrical power.

2. The capacitive pointer according to claim 1, wherein one portion of the contact device penetrates through an opening of the device holder and the other portion of the contact device is outside the device holder.

3. The capacitive pointer according to claim 1 further comprising a spring configured to surround one end of the nib holder.

4. The capacitive pointer according to claim 1, wherein one end of the contact device is through the device holder and will contact the pressure sensor after being pressed, while the other end of the contact device contacts the conductive nib in the nib holder.

5. The capacitive pointer according to claim 1, wherein a material of the contact device comprises a non-electrical conductive elastomer.

6. The capacitive pointer according to claim 1, wherein the pressure sensor is mounted on the sensor board by soldering.

7. The capacitive pointer according to claim 1, wherein the sensor board connects to the control circuit board through a flexible flat cable.

8. The capacitive pointer according to claim 1 further comprising a first structure and a second structure configured to combine to secure the nib holder, the device holder, the control circuit board and the sensor board.

9. The capacitive pointer according to claim 8, wherein the second structure comprises fillisters and partition frames for accommodating and mounting the conductive nib, the nib holder, the spring, the contact device, the device holder, the control circuit board and the sensor board.

10. A capacitive pointer, comprising:
a conductive nib;
a nib holder, wherein one end of the conductive nib is in the nib holder;
a contact device, wherein one end of the contact device is in the nib holder;
a device holder, a pressure sensor, and a sensor board, wherein the device holder covers the pressure sensor mounted on the sensor board, the contact device penetrates the device holder so that the conductive nib pushes the contact device to press the pressure sensor when a tip pressure is applied on the conductive nib, the pressure sensor detects the tip pressure applied upon the conductive nib;
a spring configured to surround one end of the nib holder and adjacent the device holder;
a control circuit board, the sensor board electrically connecting to the control circuit board; and
a power source, the power source providing the capacitive pointer apparatus with electrical power.

11. The capacitive pointer according to claim 10, wherein one portion of the contact device penetrates through an opening of the device holder and the other portion of the contact device is outside the device holder.

12. The capacitive pointer according to claim 10, wherein the sensor board connects to the control circuit board through a flexible flat cable.

13. The capacitive pointer according to claim 10 further comprising a first structure and a second structure configured to combine to secure the nib holder, the device holder, the control circuit board and the sensor board.

14. The capacitive pointer according to claim 13, wherein the second structure comprises fillisters and partition frames for accommodating and mounting the conductive nib, the nib holder, the spring, the contact device, the device holder, the control circuit board and the sensor board.

15. A capacitive pointer, comprising:
a conductive nib;
a nib holder, wherein one end of the conductive nib is in the nib holder;
a contact device, wherein a first end of the contact device is in the nib holder;
a device holder, a pressure sensor, and a sensor board, wherein the device holder covers the pressure sensor mounted on the sensor board, a second end of the contact device is in the device holder so that the conductive nib pushes the contact device to press the pressure sensor when a tip pressure is applied on the conductive nib, the pressure sensor detects the tip pressure applied upon the conductive nib;
a spring configured to surround one end of the nib holder and adjacent the device holder;
a control circuit board, the sensor board electrically connecting to the control circuit board;
a first structure and a second structure configured to combine to secure the nib holder, the device holder, the control circuit board and the sensor board; and
a power source, the power source providing the capacitive pointer apparatus with electrical power.

16. The capacitive pointer according to claim 15, wherein a material of the contact device comprises a non-electrical conductive elastomer.

17. The capacitive pointer according to claim 15, wherein the pressure sensor is mounted on the sensor board by soldering.

18. The capacitive pointer according to claim 15, wherein the sensor board connects to the control circuit board through a flexible flat cable.

19. The capacitive pointer according to claim 15, wherein the second structure comprises fillisters and partition frames for accommodating and mounting the conductive nib, the nib holder, the spring, the contact device, the device holder, the control circuit board and the sensor board.
